(19) United States
(12) Patent Application Publication
(10) Pub. No.: US 2006/0085183 A1
(43) Pub. Date: Apr. 20, 2006

(54) System and method for increasing recognition accuracy and modifying the behavior of a device in response to the detection of different levels of speech

(76) Inventor: Yogendra Jain, Wellesley, MA (US)

Correspondence Address: Yongendra Jain;Personica Intelligence, Inc., 10 South Woodside, Wellesley, MA, 02482, US

(21) Appl. No.: 11/253,318

(22) Filed: Oct. 19, 2005

Related U.S. Application Data
(60) Provisional application No. 60/619,977, filed on Oct. 19, 2004.

(51) Int. Cl. G10L 15/20

(52) U.S. Cl. 704/233

(57) ABSTRACT

The present invention discloses a system and method for controlling the response of a device after a whisper, shout, or conversational speech has been detected. In the preferred embodiment, the system of the present invention modifies its speech recognition module to detect a whisper, shout, or conversational speech (which have different characteristics) and switches the recognition algorithm model, and its speech and dialog output. For example upon detection a whisper, the device may change the dialog output to a quieter, whispered voice. When the device detects a shout it may talk back with higher volume. The device may also utilize more visual displays in response to different levels of speech.

### CROSS-REFERENCE TO RELATED APPLICATIONS

This application claims the benefit of U.S. Provisional Application No. 60/619,977 filed Oct. 19, 2004, which is incorporated by reference in its entirety herein, and from which priority is claimed.

### FIELD OF THE INVENTION

The present invention generally relates to the field of modifying the behavior of a device in response to the detection of a whisper, shout, or conversational speech or detecting a user's proximity to the device. More particularly, the present invention provides a system and method for detecting a whisper or a shout and a user's proximity using multiple detection techniques and subsequently modifying the behavior of a device in response to said whisper detection.

### BACKGROUND OF THE INVENTION

Currently there has been a strong trend to make different consumer electronics more user-friendly by incorporating multi-modal and speech-recognition technology into their operation. For example, many cell phones allow you to dial a telephone number just by speaking the associated person's name. Speech recognition software located within the cell phone decodes the spoken name, matches it to an entry in the user's address book, and then dials the number.

Additionally, many computers can now be controlled through spoken commands by installing additional third-party software. The software allows the user to perform common tasks, such as opening and saving files, telling the computer to hibernate, etc. Some programs even allow the user to dictate directly into a word processing program. Some of the newer devices such as VoIP telephone in the home use PC or some network server in the background to offer not only telephone service but can use voice to control or activate other home appliances, music, entertainment, content, services, etc.

Most consumer devices which have incorporated speech-recognition technology are usually only able to detect and respond to a normal conversation tone of voice and are not particularly well suited for responding to a wide variety of speech levels. For example, if a user attempted to whisper and/or shout a command, the device would not be likely to recognize it.

Additionally, since most consumer devices only respond at one speech level that is pre-programmed or set by the user. This may lead to the device responding to the user in a voice that is either too loud or too soft for the current circumstances. For example, if a user is located at a distance from the device and shouts a command, and the device responds in a normal tone of voice, the user is not likely to hear the response. Similarly, if a user whispers a command because a child is sleeping in the room, the device may respond and wake up the child if it does not alter its output volume level accordingly.

Therefore, there clearly exists a need for a system and method for controlling the speech level at which a device responds to spoken commands. The device should also be able to modify its speech recognition algorithm to better understand the type of speech utilized by the user (e.g., a whisper, shout, etc.).

### SUMMARY OF THE INVENTION

The present invention discloses a system and method for controlling the response of a device after a whisper, shout, or conversational speech has been detected. In the preferred embodiment, the system of the present invention modifies its speech recognition module to detect a whisper, shout, or conversational speech (which have different characteristics) and switches the recognition algorithm model, and its speech and dialog output. For example upon detection a whisper, the device may change the dialog output to a quieter, whispered voice. When the device detects a shout it may talk back with higher volume. The device may also utilize more visual displays in response to different levels of speech.

In the preferred embodiment, the system of the present invention can be implemented on any one of a plurality of client or base devices which are dispersed throughout a home. For example, a base device may be located in a home office while different client devices may be located in the bedroom, kitchen, television room, etc. All of the client devices are preferably in communication through a wireless or wired network managed by a server or a router. The speech recognition can either be performed locally on each of the client or base devices or it may all be performed at one or more central locations using a distributed processing architecture.

In the preferred embodiment of the present invention, the device capable of detecting the speech level is composed of a central processing unit (“CPU”), RAM, a speech recognition module, an interface client database, one or more speakers, one or more microphones, a visual display, a text-to-speech engine, and a speech level detection algorithm capable of distinguishing a whisper, shout, or normal speech (which can be implemented in either hardware or software). The central processing unit (“CPU”) is responsible for controlling the interaction between the different components of the device. For example, the CPU is responsible for passing voice data from the microphone, to front end processing circuitry or program, then to speech level detection program and then to the appropriate speech recognition module based on the type detected speech level for processing, controlling the output of the text-to-speech engine, etc.

The device interacts with users through different interface clients which are stored in the interface client database connected to the CPU. During normal operation, the device constantly monitors for all types of speech. Each sound received by the microphone(s) is digitized and passed to the CPU, which transmits it to the speech recognition module. If the speech recognition module recognizes an “attention word” spoken in whisper, shout, or normal speech, the device becomes active and responsive to other voice commands. It processes subsequent voice commands in a similar mode as spoken to achieve higher recognition accuracy. Since the acoustic characteristics of a shout are different than a whisper, the device will change the acoustic speech model to a shout model to achieve higher accuracy. Similar techniques are used when a telephone conversation is being speech recognized where a telephony speech model is used. After detection of an attention word, the device accesses the interface client database and loads the correct interface client into RAM. An interface client is a lifelike personality which can be customized for each user of the device and may change from device to device or application to application. Different applications used by the device, such as an application for playing music, may utilize customized interface clients to interact with the user.

Once the interface client has been loaded into RAM, it is able to communicate with the user through the speaker(s) and microphone(s) attached to the external housing of the device or speakers on another device such as a TV or whole home audio, or stereo system (e.g., through a wireless network). The interface client may also utilize the visual display to interact with the user. For example, the interface client may appear as a lifelike character on the visual display which appears to speak the words heard through the speaker. In the preferred embodiment, the interface client stays active for a predetermined amount of time, after which the device again begins monitoring for an attention word.

There is substantial difference in the whisper level (produced at a level of about 35 dB at 1 m), shout (90 dB at 1 m), and conversational voice (65 dB at 1 m). The Voice Type Detection Algorithm, which resides on the CPU or in the speech detection module, is responsible for the detection of different types of voices spoken by a user.

Whisper Detection:

To determine if a word has been whispered, the Voice Type Detection Algorithm utilizes several criteria”

1. To whisper, voice pitch needs to be changed such that there is almost no pitch in the voice. Since Larynx is used to generate the pitch, the users have to shutoff the Larynx. Detecting absence of pitch is a well know technique in speech processing.

2. When whispering to the device, the users will be physically near the device and it is most likely that the amplitude of the speech registered in one microphone is much greater than the amplitude of the speech registered in the other microphone(s). Therefore, by comparing the relative amplitudes of the speech detected in the different microphones, the whisper detection algorithm can establish a first criterion to determine if whispered speech has been spoken.

3. To confirm that a whisper has been uttered, the whisper detection algorithm also utilizes data from the microphone to detect a puff of air due to close user proximity. If the whisper detection algorithm determines that a puff of air was produced near the microphone at the same instant that the speech occurred, the whisper detection algorithm confirms that a whisper has been uttered. The detection of a puff of air near the microphone is different for different microphones and acoustic specifications of the device and microphone cavity. However, through experimentation, a model can be built to uniquely detect a user's proximity.

However, if the device only contains one microphone, slightly different criteria must be utilized to determine whispered speech. First, if only one microphone is present in the device, there is only one amplitude to measure. In this case, the whisper detection algorithm measures different characteristics of the speech such as the level of acoustic echo present in the speech. If the level of acoustic echo is below a predetermined threshold value, the whisper recognition algorithm establishes a first criterion to determine if a whisper has been detected.

To confirm the detection of a whisper (when one microphone is present), the whisper detection algorithm would then correlate the first criteria (the low acoustic echo level) with the detection of a puff of air at the microphone. If the two criteria occur within a certain time period, then the whisper detection algorithm confirms that a whisper has been uttered.

In response to a detected whisper, the CPU loads an interface client which will be referred to as the “whisper interface client.” First, the whisper interface client instructs the speech recognition module to begin monitor for commands which are whispered. Since whispered speech may be very different from normal speech, this step will usually entail loading a completely different speech recognition model into the speech recognition module. However, some speech recognition models for normal speech are also capable of recognizing whispered speech and may be utilized with the present invention.

The whisper interface client also instructs the text-to-speech engine to begin utilizing a muted, whispered voice for its speech output. Alternatively, the whisper interface client could simply instruct the speaker to output a volume at the same level (or close to) as the volume of the detected whisper. If the sound of the volume is too low for the user, the user may alter the volume of the device using a volume button.

The whisper interface client may also cause the LEDs present on the device or the display to be dimmer and/or be more active after a whisper is detected. For example, if a user whispers “Wake me up at 7:30 in the morning,” the device will display the time “7:30 A.M.” for a moment and then display text such as “Alarm set for 7:30 A.M.” The display could also be made to display an icon or text to indicate that whisper mode is currently active. Another example is when a user may ask (if the user does not want to wear glasses to see the time) “what time is it” and if the time is in middle of the night or early morning the device may speak in lower voice or whisper the time so as to not wake up others. The exact setting can be customized by the users upon device setup using the web or the device can ask the users some questions during the training period.

After the whisper interface client has been completely loaded, the device begins monitoring for normal speech patterns. Once a normal speech pattern is detected, the device loads the default, or last used interface client and again begins monitoring for whispered speech.

To enable better whisper detection, the device may also guide the user through a “training” mode during the initial setup of the device that will inform the user of the existence of the whisper mode. Also, it will demonstrate the whisper mode and allow the user to test the whisper detection capabilities of the device. In the preferred embodiment, the device would record the user's whisper and possibly utilize it as another criterion for whisper detection. Specifically, it will ask the users to whisper the ‘attention word’ near the device as the attention button may be initiator of a whispered dialog.

Shout Characteristics:

As in the whisper mode, the users may shout the ‘attention word’ where there is substantial change in the pitch and volume. The Voice Type Detection Algorithm will have a Shout Detection Algorithm. This algorithm will detect the shout in multiple ways:
1. when the algorithm detects a high speech amplitude on one or multiple microphones when compared to normal speech.
2. It notices strong changes in pitch accompanied by change in volume.

Upon detecting a shout, the device may change its behavior in one of many ways:
1. It may talk louder so the users can hear from distance
2. If the device detects that the users is in close proximity by also detecting an air puff (as in whisper detection), the device may talk in a lower volume.
   The device may ask the user to please “talk in lower v6olume as it difficult for me to understand you.” It may display information on the screen or show its attentiveness by making the display, LED, and other visual display brighter.

In applications where the users changes his talk mode from shout to normal or walks toward the device, the device can also detect the change in distance as it has general data from past speech samples. In several applications, the device may be stationary. By keep the speech input profile over time, the device can know the general distance of the user. The device may also ask the users to stand 10 feet away and say a “test word” in a normal voice and know the relative distance of users to sound level. The device can use this test/train mode to decide Shout, Whisper, or normal conversational mode.

### BRIEF DESCRIPTION OF THE DRAWINGS

The above described features and advantages of the present invention will be more fully appreciated with reference to the detailed description and appended figures in which:

FIG. 1 depicts a network diagram showing the distribution of base and client devices for use with the present invention.

FIG. 2 depicts a schematic diagram showing the preferred components located in the base and/or client devices of FIG. 1, including the speech level detection module of the present invention.

FIG. 3 depicts a flowchart showing the steps utilized by the speech level detection module to determine if a whisper has been uttered.

FIG. 4 depicts a flowchart showing the steps utilized by the speech level detection module to determine if a shout has been uttered.

### DETAILED DESCRIPTION OF THE INVENTION

The present invention discloses a system and method for controlling the response of a device after a whisper, shout, or conversational speech has been detected. In the preferred embodiment, the system of the present invention modifies its speech recognition module to detect a whisper, shout, or conversational speech (which have different characteristics) and switches the recognition algorithm model, and its speech and dialog output. For example, upon detection a whisper, the device may change the dialog output to a quieter, whispered voice. When the device detects a shout it may talk back with higher volume. The device may also utilize more visual displays in response to different levels of speech.

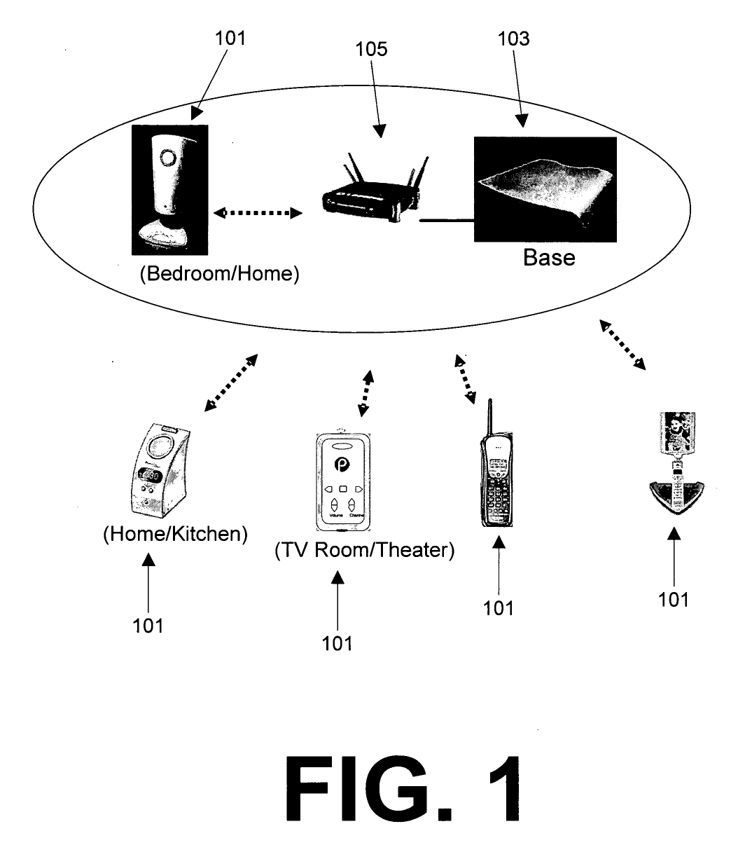

With reference to FIG. 1, depicted is a network diagram for use with the present invention. The system of the present invention can be implemented on any one of a plurality of client device 101 or base devices 103 which are dispersed throughout a home. For example, base device 103 may be located in a home office while different client devices 101 may be located in the bedroom, kitchen, television room, etc. All of the client devices are preferably in communication through a wireless network managed by wireless or wired server/router 105. The speech recognition can either be performed locally on each of the client devices 101 or base device 103, or it may all be performed at one or more central locations using a distributed processing architecture.

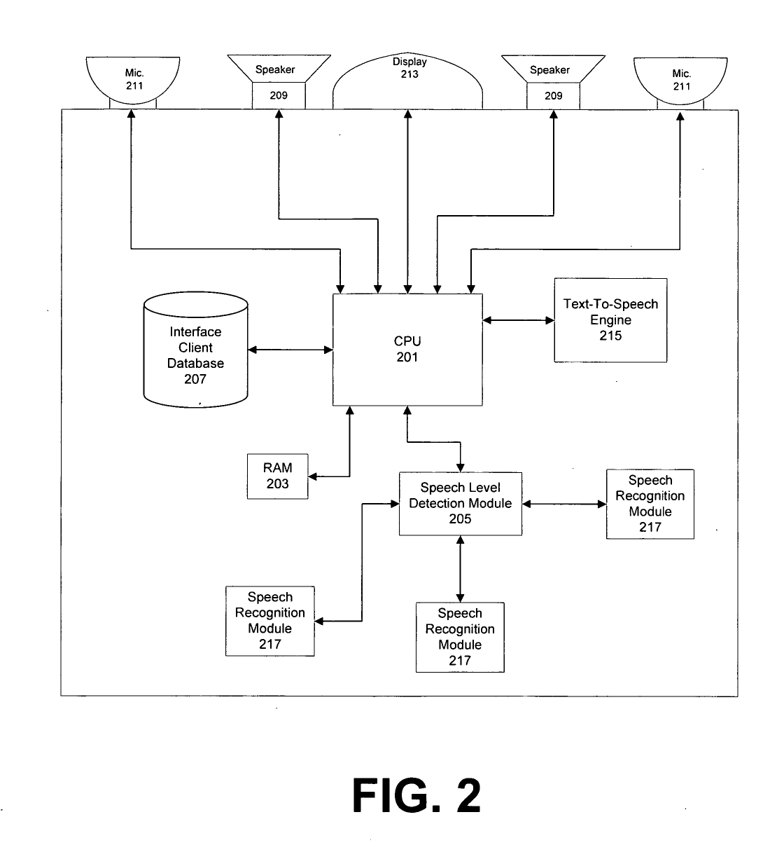

Referring next to FIG. 2, shown is a schematic diagram of the preferred components located in client devices 101. For clarity, the invention will be described with reference to client device 101, although it should be obvious to one skilled in the art that the system of the present invention could also be utilized in base devices 103.

As shown, client device 101 preferably is composed of central processing unit (“CPU”) 201, random access memory (“RAM”) 203, speech recognition module(s) 217, interface client database 207, one or more speakers 209, one or more microphones 211, visual display 213, text-to-speech engine 215, and speech level detection module 205 capable of distinguishing a whisper, shout, or normal speech (which can be implemented in either hardware or software). CPU 201 is responsible for controlling the interaction between the different components of the device. For example, CPU 201 is responsible for passing voice data from microphone(s) 211, to front end processing circuitry (not shown), then to speech level detection module 205, and then to the appropriate speech recognition module 217 based on the type detected speech level for processing, controlling the output of the text-to-speech engine, etc.

Client device 101 interacts with users through different interface clients which are stored in interface client database 207 connected to CPU 201. During normal operation, client device 101 constantly monitors for all types of speech. Each sound received by microphone(s) 211 is digitized and passed to CPU 201, which transmits it to speech level detection module 205 which differentiates between commands spoken in a whisper, shout, or normal speech. The digitized data is then passed to the appropriate speech recognition module 217 for recognition of an “attention word.” If an attention word is detected, the client device 101 becomes active and responsive to other voice commands. It processes subsequent voice commands in a similar mode as spoken to achieve higher recognition accuracy. Since the acoustic characteristics of a shout are different than a whisper, the device will change the acoustic speech model to a shout model to achieve higher accuracy. Similar techniques are used when a telephone conversation is being speech recognized where a telephony speech model is used.

After detection of an attention word, client device 101 accesses interface client database 207 and loads the correct interface client into RAM 203. An interface client is a lifelike personality which can be customized for each user of the device and may change from device to device or application to application. Different applications used by the device, such as an application for playing music, may utilize customized interface clients to interact with the user.

Once the interface client has been loaded into RAM 203, client device 101 is able to communicate with the user through speaker(s) 209 and microphone(s) 211 attached to the external housing of client device 101 or speakers on another device such as a TV or whole home audio, or stereo system (e.g., through a wireless network). The interface client may also utilize visual display 213 to interact with the user. For example, the interface client may appear as a lifelike character on the visual display which appears to speak the words heard through the speaker. In the preferred embodiment, the interface client stays active for a predetermined amount of time, after which the device again begins monitoring for an attention word.

There is substantial difference in the whisper level (produced at a level of about 35 dB at 1 m), shout (90 dB at 1 m), and conversational voice (65 dB at 1 m). The Voice Type Detection Algorithm, which resides in speech level detection module 205, is responsible for the detection of different types of voices spoken by a user.

Whisper Detection:

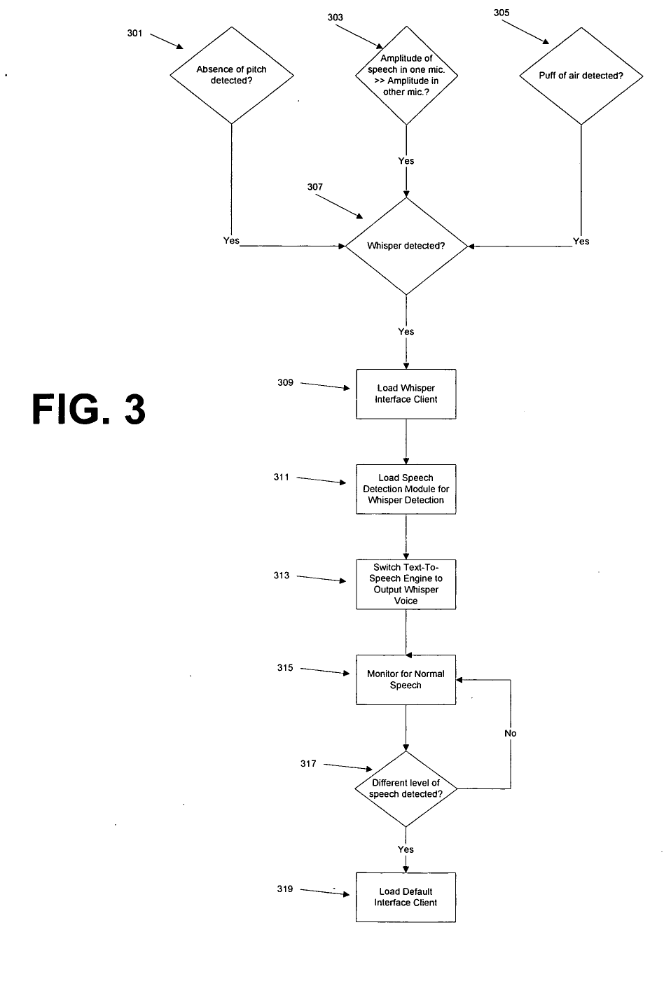

Referring next to FIG. 3, depicted is a flowchart showing the steps utilized by speech level detection module 205 to determine if a whisper has been uttered. To determine if a word has been whispered, the Voice Type Detection Algorithm utilizes several criteria:
1. To whisper, voice pitch needs to be changed such that there is almost no pitch in the voice. Since the larynx is used to generate the pitch, the users have to shutoff the larynx during a whisper. Speech level detection module 205 determines the absence of pitch in step 301.
2. When whispering to client device 101, the users will be physically near the device and it is most likely that the amplitude of the speech registered in one microphone 211 is much greater than the amplitude of the speech registered in the other microphone(s) 211. Therefore, by comparing the relative amplitudes of the speech detected in the different microphones 211, the whisper detection algorithm can establish an additional criterion to determine if whispered speech has been spoken in step 303.
3. To confirm that a whisper has been uttered, the whisper detection algorithm also utilizes data from microphone 211 to detect a puff of air due to close user proximity. If speech level detection algorithm 205 determines that a puff of air was produced near microphone 211 at the same instant that the speech occurred, the whisper detection algorithm establishes a third criterion to determine if a whisper has been spoken in step 305.
   The detection of a puff of air near the microphone is different for different microphones and acoustic specifications of the device and microphone cavity. However, through experimentation, a model can be built to uniquely detect a user's proximity.

The detection of a whisper is confirmed in step 307 by correlating the different criteria from steps 301, 303, and 305. If a positive response occurred in two or more of those steps, the device assumes that the user is speaking in a whispered voice.

However, if client device 101 only contains one microphone 211, slightly different criteria must be utilized to determine whispered speech. First, if only one microphone 211 is present in client device 101, there is only one amplitude to measure. In this case, speech level detection module 205 measures different characteristics of the speech such as the level of acoustic echo present in the speech. If the level of acoustic echo is below a predetermined threshold value, speech level detection module 205 establishes a first criterion to determine If a whisper has been detected.

To confirm the detection of a whisper (when one microphone is present), the whisper detection algorithm would then correlate the first criteria (the low acoustic echo level) with the detection of a puff of air at the microphone. If the two criteria occur within a certain time period, then the whisper detection algorithm confirms that a whisper has been uttered.

In response to a detected whisper, CPU 201 loads an interface client which will be referred to as the “whisper interface client” in step 309. First, the whisper interface client instructs speech recognition module to begin monitor for commands which are whispered. Since whispered speech may be very different from normal speech, this step will usually entail utilizing a completely different speech recognition module 217 in step 311. However, some speech recognition modules 217 for normal speech are also capable of recognizing whispered speech and may be utilized with the present invention.

The whisper interface client also instructs text-to-speech engine 125 to begin utilizing a muted, whispered voice for its speech output in step 313. Alternatively, the whisper interface client could simply instruct the speaker to output a volume at the same level (or close to) as the volume of the detected whisper. If the sound of the volume is too low for the user, the user may alter the volume of the device using a volume button located on client device 101.

The whisper interface client may also cause the LEDs present on client device 101 or visual display 213 to become dimmer and/or be more active after a whisper is detected. For example, if a user whispers “Wake me up at 7:30 in the morning,” the device will display the time “7:30 A.M.” for a moment and then display text such as “Alarm set for 7:30 A.M.” Visual display 213 could also be made to display an icon or text to indicate that whisper mode is currently active. Another example is when a user may ask (if the user does not want to wear glasses to see the time) “what time is it” and if the time is in middle of the night or early morning the device may speak in lower voice or whisper the time so as to not wake up others. The exact setting can be customized by the users upon device setup using the web or the device can ask the users some questions during the training period.

After the whisper interface client has been completely loaded, the device begins monitoring for different speech levels (i.e., normal voice or shouting) in step 315. Once a different speech level is detected in step 317, the device loads the default, or last used interface client and again begins monitoring for whispered or shouted speech in step 319.

To enable better whisper detection, client device 101 may also guide the user through a “training” mode during the initial setup of the device that will inform the user of the existence of the whisper detection. Also, it will demonstrate the whisper detection and allow the user to test the whisper detection capabilities of the device. In the preferred embodiment, the device would record the user's whisper and possibly utilize it as another criteria for whisper detection. Specifically, it will ask the users to whisper the ‘attention word’ near the device as the attention button may be initiator of a whispered dialog.

Shout Detection

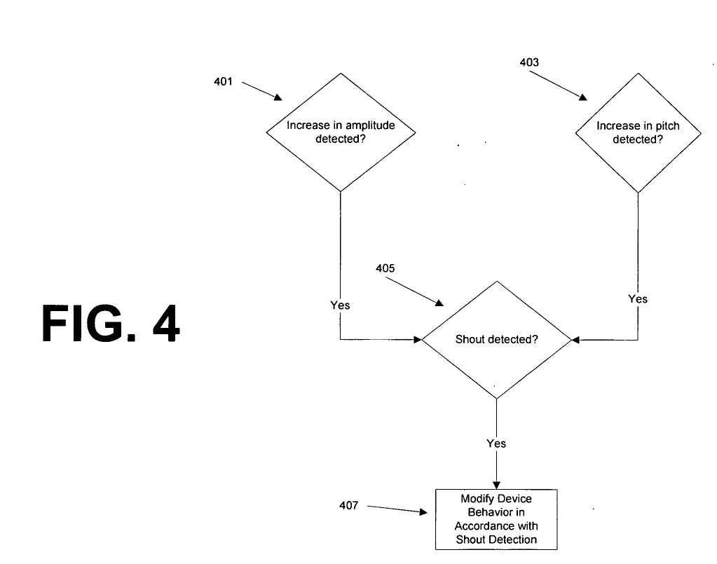

Referring next to FIG. 4, depicted is a flowchart showing the steps utilized by speech level detection module 205 to determine if a shout has been uttered. Speech level detection module 205 will detect the shout in multiple ways:
1. A shout often results in a high speech amplitude being registered in microphone(s) 211. When speech level detection module 205 detects a high speech amplitude, it establishes a first criterion for detecting a shout in step 401.

An additional criterion for detecting a shout is established by monitoring for a large increase in pitch in step 403. A shout is confirmed in step 405 if both an increase in pitch and amplitude are detected in the user's voice.

Upon detecting a shout, client device 101 may change its behavior in one of many ways in step 407:
1. It may talk louder so the users can hear from distance
2. If the device detects that the users is in close proximity by also detecting an air puff (as in whisper detection), the device may talk in a lower volume.
   The device may ask the user to please “talk in lower volume as it difficult for me to understand you.” It may display information on the screen or show its attentiveness by making the display, LED, and other visual display brighter.

In applications where the users changes his talk mode from shout to normal or walks toward the device, the device can also detect the change in distance as it has general data from past speech samples. In several applications, the device may be stationary. By keep the speech input profile over time, the device can know the general distance of the user. The device may also ask the users to stand 10 feet away and say a “test word” in a normal voice and know the relative distance of users to sound level. The device can use this test/train mode to decide Shout, Whisper, or normal conversational mode.

While specific embodiments of the present invention have been illustrated and described, it will be understood by those having ordinary skill in the art that changes may be made to those embodiments without departing from the spirit and scope of the invention.

I claim:

1. A method for controlling the response of a device after a whisper, shout, or conversational speech has been detected. In the preferred embodiment, the system of the present invention modifies its speech recognition module to detect a whisper, shout, or conversational speech (which have different characteristics) and switches the recognition algorithm model, and its speech and dialog output, personality, mode of operation, and type of information that it presents to users.

2. A method according to claim 1, wherein said specific event is when upon detecting a whisper, the device may change the dialog output to a quieter, whispered voice. When the device detects a shout it may talk back with higher volume. The device may also utilize more visual displays in response to different levels of speech. a user pushes an attention button located on said device.

3. A method according to claim 1, to confirm that a whisper has been uttered, the whisper detection algorithm also utilizes data from the microphone to detect a puff of air due to close user proximity. If the whisper detection algorithm determines that a puff of air was produced near the microphone at the same instant that the speech occurred, the whisper detection algorithm confirms that a whisper has been uttered.

4. A method according to claim 1, the users may shout the ‘attention word or a command’ where there is substantial change in the pitch and volume or other voice characteristics. The Voice Type Detection Algorithm will have a Shout Detection Algorithm and based on what it detects will appropriately change devices personality, mode of operation, response, etc.
